(19) United States
(12) Patent Application Publication
(10) Pub. No.: US 2012/0290664 A1
(43) Pub. Date: Nov. 15, 2012

(54) CROSS-MEDIA, CROSS-CHANNEL, CROSS-PROTOCOL, AND CROSS-NETWORK CAPABLE AUTOREPLY WITHIN A SINGLE APPLICATION

(75) Inventors: Zafer Ahmed, Palatine, IL (US); Nan Zhong, Bellevue, WA (US)

(73) Assignee: TIKL, INC., Sunnyvale, CA (US)

(21) Appl. No.: 13/464,832

(22) Filed: May 4, 2012

Related U.S. Application Data
(60) Provisional application No. 61/484,928, filed on May 11, 2011.

(51) Int. Cl. G06F 15/16

(52) U.S. Cl. 709/206

(57) ABSTRACT

According to one embodiment, a communication device capable of cross-media, cross-channel, cross-protocol messaging within a first application includes a processor adapted for executing logic, logic adapted for receiving an incoming message using the first application, logic adapted for notifying a user of the incoming message using the first application, logic adapted for processing the incoming message using the first application to determine details of the incoming message, logic adapted for determining to generate an autoreply to the incoming message using the first application, logic adapted for generating the autoreply to the incoming message using the first application, and logic adapted for sending the autoreply using the first application to at least a communication device which generated the incoming message. Other systems, methods, and computer program products for autoreplying are presented according to more embodiments.

### RELATED APPLICATIONS

This application claims priority to U.S. Provisional Patent Application No. 61/484,928 filed on May 11, 2011, which is herein incorporated by reference.

### FIELD OF THE INVENTION

The present invention relates to electronic messaging, and more particularly, this invention relates to transmitting an autoreply capable of cross-media cross-channel cross-protocol usage within a single application.

### BACKGROUND

Communication devices, such as mobile telephones, smart phones, personal computers, tablet-based computers, etc., are generally capable of transmitting and receiving voice calls and/or sending and receiving data over at least one of many different types of communication networks. However, at times, a user may be away from his or her communication device or otherwise unavailable to engage in communications. Consequently, some current communication applications offer an autoreply function that, when certain conditions are met, automatically send a reply on behalf of the user. This autoreply function helps a user manage his or her communications when it is inconvenient or impossible to manually reply to the incoming message.

As communication devices become increasingly powerful, communications may include a plurality of media types and may occur over a plurality of channels, protocols, and networks. Thus, there is currently no consistency for which type of autoreply message is sent or how it is sent in response to such varied communications. This means that there is no way to determine a best way to send an autoreply message based on the plurality of different data types, communication channels, protocols, and/or networks.

### SUMMARY

In one embodiment, a computer program product for responding to an incoming message includes a computer readable storage medium having computer readable program code embodied therewith, the computer readable program code including computer readable program code configured for receiving an incoming message using a first application on a receiver communication device, computer readable program code configured for processing the incoming message using the first application to determine details of the incoming message, computer readable program code configured for determining to generate an autoreply to the incoming message using the first application, computer readable program code configured for generating the autoreply to the incoming message using the first application, and computer readable program code configured for sending the autoreply using the first application to at least a communication device which generated the incoming message.

In another embodiment, a method for automatically replying to a message includes receiving an incoming message using a first application on a receiver communication device, notifying a user at the receiver communication device of the incoming message using the first application, processing the incoming message using the first application to determine details of the incoming message, determining to generate an autoreply to the incoming message using the first application, generating the autoreply to the incoming message using the first application, and sending the autoreply using the first application to at least a communication device which generated the incoming message.

In yet another embodiment, a communication device includes a processor adapted for executing logic, logic adapted for receiving an incoming message using a first application, logic adapted for notifying a user of the incoming message using the first application, logic adapted for processing the incoming message using the first application to determine details of the incoming message, logic adapted for determining to generate an autoreply to the incoming message using the first application, logic adapted for generating the autoreply to the incoming message using the first application, and logic adapted for sending the autoreply using the first application to at least a communication device which generated the incoming message.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 illustrates a network architecture, according to one embodiment.

FIG. 2 shows a representative hardware environment, according to one embodiment.

FIGS. 3A-3D depict exemplary autoreply scenarios, according to various exemplary embodiments.

FIG. 4 depicts a flowchart of a method, according to one illustrative embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The following description discloses several preferred embodiments for transmitting an autoreply capable of cross-media, cross-channel, cross-protocol, and/or cross-network usage within a single application and/or related systems and methods thereof.

In one general embodiment, a computer program product for responding to an incoming message includes a computer readable storage medium having computer readable program code embodied therewith, the computer readable program code including computer readable program code configured for receiving an incoming message using a first application on a receiver communication device, computer readable program code configured for processing the incoming message using the first application to determine details of the incoming message, computer readable program code configured for determining to generate an autoreply to the incoming message using the first application, computer readable program code configured for generating the autoreply to the incoming message using the first application, and computer readable program code configured for sending the autoreply using the first application to at least a communication device which generated the incoming message.

hi another general embodiment, a method for automatically replying to a message includes receiving an incoming message using a first application on a receiver communication device, notifying a user at the receiver communication device of the incoming message using the first application, processing the incoming message using the first application to determine details of the incoming message, determining to generate an autoreply to the incoming message using the first application, generating the autoreply to the incoming message using the first application, and sending the autoreply using the first application to at least a communication device which generated the incoming message.

In yet another general embodiment, a communication device includes a processor adapted for executing logic, logic adapted for receiving an incoming message using a first application, logic adapted for notifying a user of the incoming message using the first application, logic adapted for processing the incoming message using the first application to determine details of the incoming message, logic adapted for determining to generate an autoreply to the incoming message using the first application, logic adapted for generating the autoreply to the incoming message using the first application, and logic adapted for sending the autoreply using the first application to at least a communication device which generated the incoming message.

The description herein is presented to enable any person skilled in the art to make and use the invention and is provided in the context of particular applications of the invention and their requirements. Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

In particular, various embodiments of the invention discussed herein are implemented using the Internet as a means of communicating among a plurality of computer systems. One skilled in the art will recognize that the present invention is not limited to the use of the Internet as a communication medium and that alternative methods of the invention may accommodate the use of a private intranet, a Local Area Network (LAN), a Wide Area Network (WAN), a Virtual Local Area Network (VLAN), or some other type of communication. In addition, various combinations of wired, wireless (e.g., radio frequency), and optical communication links may be utilized.

The program environment in which one embodiment of the invention may be executed illustratively incorporates one or more general-purpose computers or special-purpose devices such hand-held computers. Details of such devices (e.g., processor, memory, data storage, input and output devices) are well known and are omitted for the sake of clarity.

It should also be understood that the techniques of the present invention might be implemented using a variety of technologies. For example, the methods described herein may be implemented in software running on a computer system, or implemented in hardware utilizing one or more processors and logic (hardware and/or software) for performing operations of the method, application specific integrated circuits, programmable logic devices such as Field Programmable Gate Arrays (FPGAs), and/or various combinations thereof. In one illustrative approach, methods described herein may be implemented by a series of computer-executable instructions residing on a storage medium such as a physical (e.g., non-transitory) computer-readable medium. In addition, although specific embodiments of the invention may employ object-oriented software programming concepts, the invention is not so limited and is easily adapted to employ other forms of directing the operation of a computer.

The invention can also be provided in the form of a non-volatile computer program product comprising a computer readable medium having computer code thereon, which may be executed by a computing device (e.g., a processor) and/or system. A computer readable medium can include any medium capable of storing computer code thereon for use by a computing device or system, including optical media (e.g., read-only and writeable Compact Disc (CD), Digital Versatile Disc (DVD), and BLU-RAY disc (BD)), magnetic memory or medium (e.g., hard disk drive (HDD), tape, etc.), semiconductor memory (e.g., FLASH memory and other portable memory cards), etc.

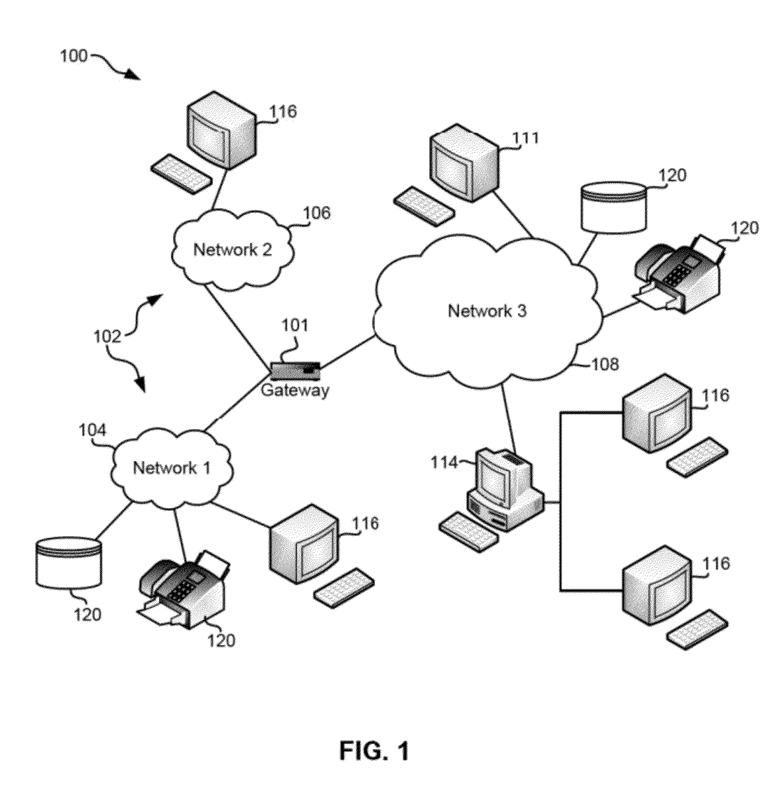

FIG. 1 illustrates a network architecture 100, in accordance with one embodiment. As shown in FIG. 1, a plurality of remote networks 102 are provided including a first remote network 104 and a second remote network 106. A gateway 101 may be coupled between the remote networks 102 and a proximate network 108. In the context of the present network architecture 100, the networks 104, 106 may each take any form including, but not limited to a LAN, a WAN such as the Internet, PSTN, internal telephone network, etc.

In use, the gateway 101 serves as an entrance point from the remote networks 102 to the proximate network 108. As such, the gateway 101 may function as a router, which is capable of directing a given packet of data that arrives at the gateway 101, and a switch, which furnishes the actual path in and out of the gateway 101 for a given packet.

Further included is at least one data server 114 coupled to the proximate network 108, and which is accessible from the remote networks 102 via the gateway 101. It should be noted that the data server(s) 114 may include any type of computing device/groupware. Coupled to each data server 114 is a plurality of user devices 116. Such user devices 116 may include a desktop computer, laptop computer, hand-held computer, printer or any other type of logic. It should be noted that a user device 111 may also be directly coupled to any of the networks, in one embodiment.

A peripheral 120 or series of peripherals 120, e.g. facsimile machines, printers, networked storage units, etc., may be coupled to one or more of the networks 104, 106, 108. It should be noted that databases, servers, and/or additional components may be utilized with, or integrated into, any type of network element coupled to the networks 104, 106, 108. In the context of the present description, a network element may refer to any component of a network.

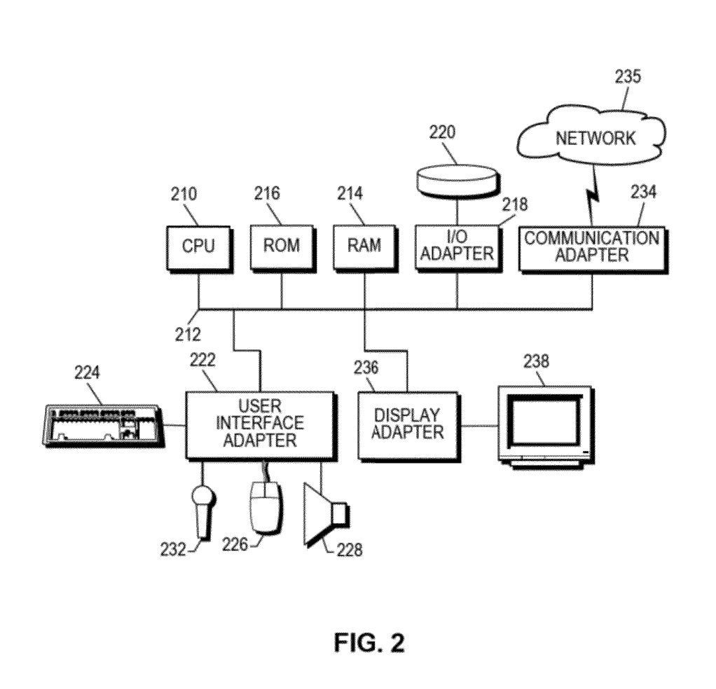

FIG. 2 shows a representative hardware environment associated with a user device 116 and/or server 114 of FIG. 1, in accordance with one embodiment. Such figure illustrates a typical hardware configuration of a workstation having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen and a digital camera (not shown) to the bus 212, communication adapter 234 for connecting the workstation to a communication network 235 (e.g., a data processing network) and a display adapter 236 for connecting the bus 212 to a display device 238.

The workstation may have resident thereon an operating system such as the Microsoft WINDOWS Operating System (OS), a MAC OS, a UNIX OS, etc. It will be appreciated that a preferred embodiment may also be implemented on platforms and operating systems other than those mentioned. A preferred embodiment may be written using JAVA, XML, C, and/or C++ language, or other programming languages, along with an object oriented programming methodology. Object oriented programming (OOP), which has become increasingly used to develop complex applications, may be used.

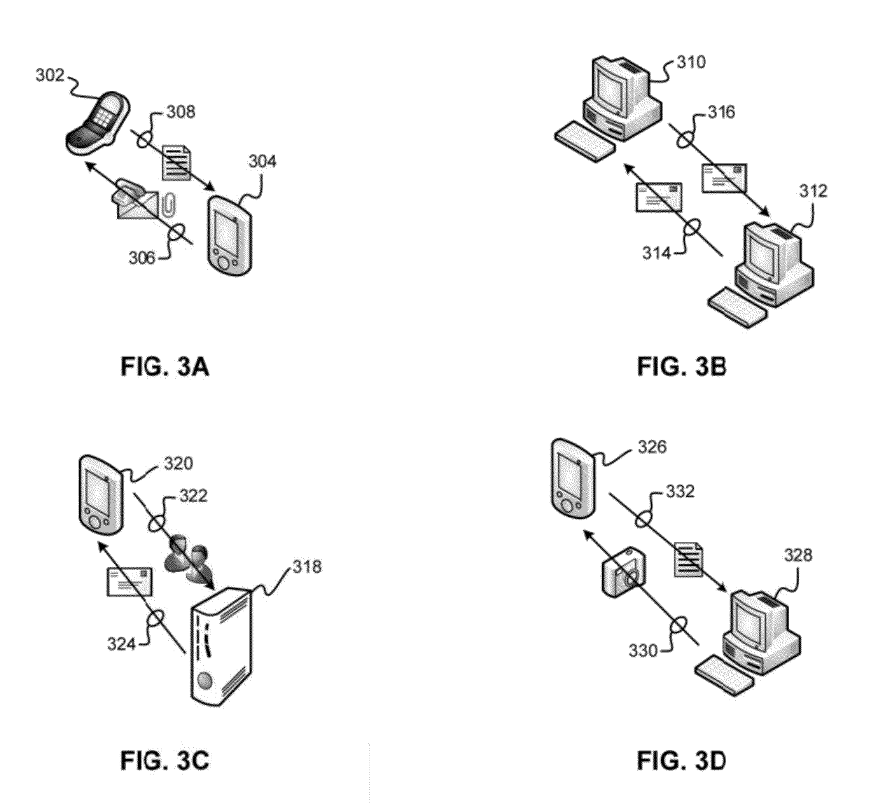

FIGS. 3A-3D show exemplary communication sessions between various exemplary communication devices. In each of these exemplary communication sessions, the receiver communication device is capable of cross-media, cross-channel, cross-protocol messaging and autoreplying within a single application (a first application). Although the first application may interface, communicate, and/or utilize other applications in the performance of certain tasks, the first application is also capable of performing each operation on its own independent of any other application operating on the receiver communication device.

In FIG. 3A, a receiver mobile phone 302 which received a call 306 from an originator smart phone 304 is shown sending an autoreply 308 via a text message back to the originator smart phone 304. In FIG. 3B, a receiver personal computer (PC) 310 which received an email 314 from an originator PC 312 is shown sending an autoreply 316 via an email back to the originator PC 312. In FIG. 3C, a receiver game console 318 which received a chat session request 322 from an originator smart phone 320 is shown sending am autoreply 324 via an email back to the originator smart phone 320. In FIG. 3D, a receiver smart phone 326 which received a text message 330 from an originator PC 328 is shown sending an autoreply 332 via a video message back to the originator PC 328. Of course, any type of communication, communication device, communication protocol, communication network, etc., may be used, as described herein and as would be understood by one of skill in the art upon reading the present descriptions.

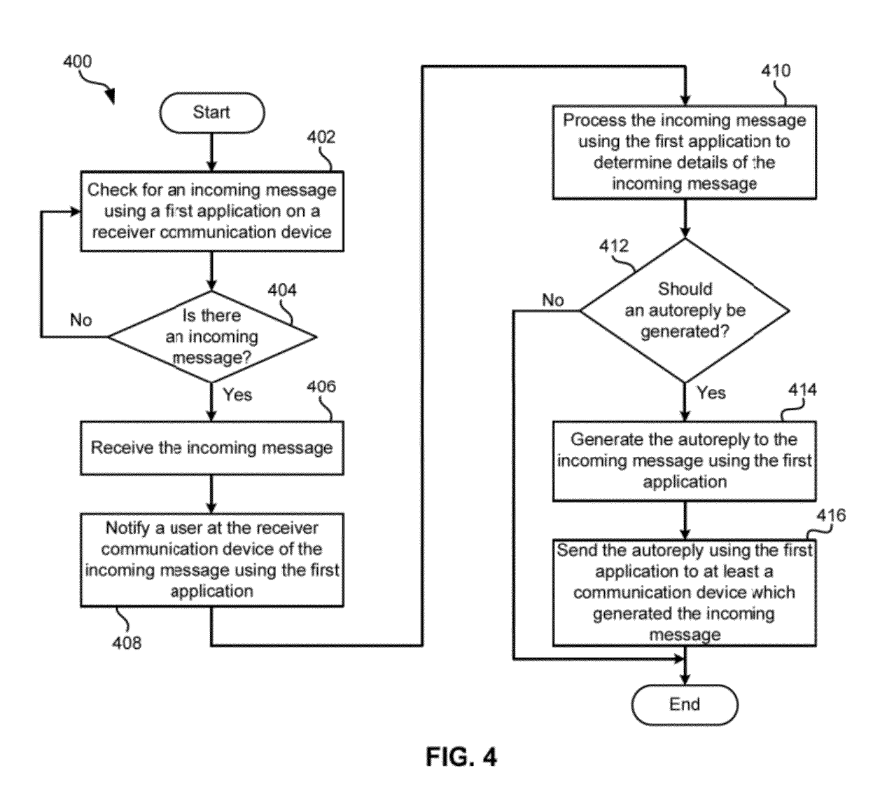

Now referring to FIG. 4, a method 400 for responding to an incoming message is shown according to one embodiment. It should be noted that the method 400 may be carried out in any desired environment, including but not limited to those shown in FIGS. 1-3, in various approaches. Moreover, more or less operations than those shown in FIG. 4 may be included in method 400, according to various embodiments. Additionally, any of the aforementioned features may be used in any of the embodiments described in accordance with the various methods.

A message as described herein may include any sort of communication, such as a telephone call, a text message, a video call, a chat session, etc.

The communication devices described herein according to various embodiments may have the capability to communicate over a variety of networks using a variety of communication protocols. The networks may include, but not limited to, the Internet, Ethernet, Global System for Mobile Communications (GSM), Code Division Multiple Access (CDMA), wide area network (WAN) including WiFi, local area network (LAN), virtual local area network (VLAN), and other suitable networks as would be understood by one having skill in the art upon reading the present disclosure.

Moreover, communication devices, as disclosed herein, may have the capability to communicate over a variety of communication channels including, but not limited to, audio channels, video channels, text channels, data channels, etc., such as CDMA channels, GSM channels, BLUETOOTH, etc., and other suitable communication channels as would be understood by one having ordinary skill in the art upon reading the present disclosure.

Further, a communication device may have the capability to communicate in accordance with a variety of communication protocols, including, but not limited to, Internet Protocol (IP), Transmission Control Protocol (TCP), User Datagram Protocol (UDP), Internet Control Message Protocol (ICMP), Hypertext Transfer Protocol (HTTP), Post Office Protocol (POP3), File Transfer Protocol (FTP), Internet Message Access Protocol (IMAP), etc. and other suitable communication protocol as would be understood having ordinary skill in the art upon reading the present disclosure.

In addition, communication devices, as used herein, may be capable of sending and receiving voice calls along with other functionality associated with phone calls, capable of simple data applications, texting, short message service (SMS), multimedia messaging service (MMS), image transmission, downloading applications (apps) from app stores, sending and receiving data, accessing the Internet, synching with email, calendars, downloading apps from app stores, etc., as would be understood by one having ordinary skill in the art upon reading the present disclosure.

As used herein, communication devices may include, but are not limited to, mobile phones, smart phones, cellular phones, flip phones, personal digital assistants, laptops, personal computers (PCs), tablet-based portable computers, mobile computers, etc. Some examples of suitable communication devices include, but are not limited to, MOTOROLA RAZR, BLACKBERRY devices, ANDROID-based smart phones such as MOTOROLA DROID, HTC EVO, GOOGLE NEXUS, etc., APPLE iPADs, APPLE iPHONEs, APPLE MACBOOKs, MICROSOFT WINDOWS-based smart phones, SAMSUNG GALAXY TAB devices, MICROSOFT TABLET PCs, HP SLATE devices, HP TOUCHPAD devices, AMAZON KINDLE devices, etc.

In addition, communication devices, as used herein, may be capable of sending and receiving voice calls along with other functionality associated with phone calls, capable of simple data applications, such as texting, short message service (SMS), image transmission, downloading applications (apps) from app stores, etc.

Some app stores which may have content which may be downloaded to any communication device described herein may include AMAZON APPSTORE, APPLE APP STORE, ANDROID MARKET, GOOGLE PLAY, etc.

Additionally, an incoming message may include different data types. As used herein, data types may include, but are not limited to, text, image, audio, video, etc. and other suitable media types as would be understood by one having ordinary skill in the art upon reading the present disclosure. In one embodiment, an incoming message may include a plurality of data types, some similar and some different, multiples of certain data types, or any combination thereof.

After the method 400 starts, as shown in operation 402, a receiver communication device checks for an incoming message using a first application. The first application maybe any application capable of receiving, processing, and responding to messages of a type desired by a user. For example, the first application may be capable of receiving, processing, and responding to text messages, e.g., SMS, MMS, etc., telephone calls from landline and/or mobile devices, push-to-talk (PTT) communications, email messaging from mobile devices, computers, laptops, etc., social media messaging, in-game messaging from devices like MICROSOFT XBOX, SONY PLAYSTATION, NINTENDO WII, PCs, etc., or any other type of messaging known in the art. The first application may be configured to receive incoming messages of this type or to recognize when messages of this type are received by another application. The receipt of a message is what triggers an autoreply, as long as other conditions and/or criteria are met, according to various embodiments described herein.

If an incoming message is detected in operation 404 using the first application, the receiver communication device receives the incoming message using the first application, as shown in operation 406. Any method of detecting an incoming message may be used as blown in the art.

For example, the receiver communication device may include logic for scanning communication channel(s) for received data. In another example, all data received may be routed through an interface adapted for recognizing messages or data which utilize one or more designated protocols, such as internet protocol (IP), SMS, MMS, hyper text markup language (HTML) and other markup languages, FLASH video, etc. The user of the receiver communication device may, according to one embodiment, specify which protocols are designated for recognition. According to another example, the receiver communication device may utilize logic configured for determining when data is received from one or more particular communication networks, such as 2G packet switched networks, 2.5G packet switched networks, 3G packet switched networks, 4G packet switched networks (4G LTE, etc.), GSM, CDMA, WiFi, and other networks as would be recognized by one having ordinary skill in the art upon reading the present disclosure.

Once the receiver communication device receives the incoming message, the receiver communication device processes the incoming message using the first application to determine details of the incoming message, as shown in operation 408.

Details of the incoming message according to various embodiments may include, but are not limited to, information about the sender (such as the sender's email address, the sender's phone number, the sender's name, the sender's company or school, or any other identifying information known in the art), a protocol of the message, a communication channel on which the message was received, a communication network on which the message was transmitted, a date the message was sent and/or received, a time the message was sent and/or received, a size of the message, a type of data included in the message, or any other details as would be understood by one of skill in the art upon reading the present descriptions.

The first application, according to various embodiments, may process the incoming message in any way, such as filtering, analyzing, reading, displaying, audibilizing, storing, etc., or in any other way determining a content of the message, an intended recipient of the message, a type of data included in the message, etc.

As shown in operation 410, the user may be notified at the receiver communication device of the incoming message using the first application. As used herein, a notification may include but is not limited to, an audible notification such as a beep, a ringtone, voice instruction, a song, singing, chiming, etc., a visible notification such as display of the sender's email address or other identification information, display of the sender's picture, display of a graphic associated with the sender, display of content of the message, etc., a vibration of the receiver communication device, and other suitable sensory notifications as would be understood by one having skill in the art upon reading the present disclosure.

As shown in operation 412, a determination to generate an autoreply to the incoming message is made using the first application. In one embodiment, the determination to generate an autoreply to the incoming message may be based on a user setting in the first application. For example, the user's chosen user settings may dictate a YES or NO determination, resulting in the autoreply being sent or not sent, respectively.

In one embodiment, the user may select to either send or not send the autoreply using the first application, such as by using a graphical user interface (GUI) in the first application. For example, if the receiver communication device has the user setting selected to not send the autoreply, then an autoreply will not be generated and sent, until and unless the user makes a selection to generate and send the autoreply. In one approach, any incoming message that was transmitted prior to selection to allow autoreplying may not receive an autoreply from the receiver communication device. In another approach, any incoming message that was transmitted prior to selection to allow autoreplying may be stored, and receive an autoreply once the selection is made.

In another embodiment, the determination to generate an autoreply to the incoming message may be based on one or more details of the incoming message. For example, details of the incoming message such as those described previously or any of details as would be understood by one having ordinary skill in the art upon reading the present disclosure.

For example, user settings may indicate that all messages received from individuals at a particular company should receive autoreplies when the receiver communication device is switched to silent mode. In another example, user settings may indicate that messages received from a user's wife may receive an autoreply during normal business hours (e.g., between 9:00 AM and 5:00 PM or any other such timeframe). According to another example, an incoming message which includes a video file received on a communication device intended to be used by an employee of a certain company may receive an autoreply indicating that the content of the message is inappropriate for the intended recipient. Of course, many other situations may arise where an autoreply may be sent to an incoming message, and the format of the autoreply, the communication protocol used, and/or the content of the autoreply may change as would be understood by one of skill in the art upon reading the present descriptions. In a further embodiment, an autoreply may be sent for all messages received (regardless of data type, communication protocol, channel, or network) after a certain time (e.g., bedtime, after work, etc.) using a SMS message. In this way, a text message may be sent out for all messages received after bedtime indicating that the receiver is sleeping (or at least should be sleeping).

In yet another embodiment, determination to generate an autoreply to the incoming message may be automatically selected by the receiver communication device based on a condition. For example, the condition may include, but is not limited to, a silent mode being active, a vibrate mode being active, a plane mode being active, a position of the receiver communication device relative to a reference position, an orientation of the receiver communication device relative to the reference position, recent movement of the receiver communication device, a velocity of the receiver communication device movement, a geographical location of the receiver communication device, a current time, user data stored to the receiver communication device, a user input to the receiver communication device, ambient noise detected by the receiver communication device, weather conditions detected by the receiver communication device, environmental factors detected by the receiver communication device, a season, user gestures, a newsfeed, a user's social media profile, etc.

If operation 412 results in a YES determination, an autoreply is generated to the incoming message using the first application as shown in operation 414. In one embodiment, the autoreply may be dynamically generated based on one or more of the details of the incoming message. In another embodiment, the autoreply may be automatically generated based on a user setting in the first application. In yet another embodiment, the autoreply may be automatically generated based on one or more of the conditions described above or any other condition known in the art.

For example, if the incoming message is a SMS message, the autoreply may be an SMS message. In another embodiment, if the message is a phone call, the autoreply may be an email indicating the unavailability of the receiving user.

Additionally, content of the autoreply may be generated in any of various different ways. For example, in one embodiment, a user at the receiver communication device may specify the content of the autoreply. In another embodiment, the content of the autoreply may be dynamically generated based on the details of the incoming message. In yet another embodiment, the content of the autoreply may be dynamically generated base on one or more conditions.

Moreover, in one embodiment, the content of the autoreply may be dynamically generated based on the one or more conditions and details of the incoming message. In addition, the content of the autoreply may include user specified content and dynamically generated content from the first application based on the one or more conditions and details of the incoming message.

In one example, content of the autoreply may simply indicate that the user is unavailable, either in text, audio, or video format. However, content may be more advanced than simply indicating unavailability. For example, if a caller from California is trying to reach a user on his mobile phone in Scotland, an autoreply may comprise a text message sent back indicating that the user is in Scotland. In another example, if a text message is received from an ex-girlfriend, an autoreply may be sent indicating that the user no longer uses this phone number, and to stop trying to contact the user at this number. Of course, there are literally infinite amounts of combinations that may be created based on the embodiments described herein.

The autoreply May include a variety of data types. As used herein, data types may include, but are not limited to, text data, image data, audio data, video data, etc., and other suitable data types as would be understood by one having ordinary skill in the art upon reading the present disclosure.

In one embodiment, the autoreply may include a plurality of different data types, some similar and some different, multiples of certain media, or any combination thereof. In another embodiment, the autoreply may include the data type as the incoming message from the originator communication device. In yet another embodiment, the autoreply may include a different media type than the incoming message from the originator communication device.

Additionally, the autoreply may include a variety of languages. As used herein, languages may include, but are not limited to, English, Spanish, French, Mandarin, Arabic, Portuguese, Russian, Japanese, German, Vietnamese, Korean, Italian, Dutch, etc., and other language as would be understood by one having skill in the art upon reading the present disclosure. In one embodiment, the autoreply may include a plurality of different languages. In another embodiment, the autoreply may include the same language as the incoming message from the originator communication device. In another embodiment, the autoreply may include a language different from the incoming message.

After the autoreply is generated in operation 414, the autoreply is sent using the first application to at least a communication device which generated the incoming message, as shown in operation 416. In one embodiment, the autoreply may be transmitted over a communication channel on which the incoming message is received. In another embodiment, the autoreply may be transmitted over a different communication channel than on which the incoming message is received.

In yet another embodiment, the autoreply may be transmitted over a communication network on which the incoming message is received. In another embodiment, the autoreply may be transmitted over a different communication network than on which the incoming message is received.

Additionally, in one embodiment, the autoreply may utilize the same communication protocol as the incoming message form the originator communication device. In another embodiment, the autoreply may utilize a different communication protocol than the incoming message.

Moreover, in one embodiment the autoreply may be sent to a plurality of recipient devices according to a group communication session. For example, an autoreply email may be generated to all employees at a certain company in response to one employee at that company trying to call the receiver communication device. In another example, a one-to-group PTT session may be established as an autoreply to an incoming PIT request from one member of the group. In yet another embodiment, an autoreply may be sent to each member of a team in response to a message being received from one member of the team.

If operation 412 results in a NO determination, an autoreply is not sent. In this instance, an indication may be made on the receiver communication device indicating that an autoreply was not sent, while allowing any other application to handle the message, such as by providing a voicemail, indicating receipt of an email or text, displaying an image of a caller, etc.

In yet another embodiment, the method 400 as described herein and shown in FIG. 4, may be implemented as a computer program product having a computer readable storage medium and computer readable program code embodied therewith. In accordance with one embodiment, computer readable program code may be configured to: receive an incoming message using a first application on a receiver communication device; process the incoming message using the first application to determine the details of the incoming message; determine to generate an autoreply to the incoming message using the first application; generate the autoreply to the incoming message using the first application; and send the autoreply using the first application to at least a communication device which generated the incoming message. Any other approaches and/or embodiments described herein may also be used in conjunction with the computer program product as would be understood by one of skill in the art upon reading the present descriptions.

In one embodiment, the computer program product may be embodied in an application (app) accessible on a remotely located (in proximity to the communication device) and wirelessly accessible server, such as an app store of some kind. In this way, the computer program product may be downloaded from the app store as an executable to be installed on the communication device for use in communications with other communication devices over any communication protocol, channel, and/or network accessible to the devices. Of course, other methods of obtaining the computer program product may be used as known in the art.

In yet another embodiment, the method described herein and shown in FIG. 4 may be implemented as a communication device to automatically generate and send an autoreply. The communication device may include a processor adapted for executing logic, such as a central processing unit (CPU), field programmable gate array (FPGA), application specific integrated circuit (ASIC), etc. Additionally, the communication device may include logic adapted for: receiving an incoming message using a first application on a receiver communication device; notifying a user of the incoming message using the first application; processing the incoming message using the first application to determine the details of the incoming message; determining to generate an autoreply to the incoming message using the first application; generating the autoreply to the incoming message using the first application; and sending the autoreply using the first application to at least a communication device which generated the incoming message. Any other approaches and/or embodiments described herein may also be used in conjunction with the computer program product as would be understood by one of skill in the art upon reading the present descriptions.

Some specific examples are now provided for how the autoreply feature may be used. The examples are not meant to be limiting on the invention in any way, and other devices, protocols, networks, channels, etc., may be used in addition to or in place of the examples provided herein.

In a first specific example, an autoreply feature may be embedded in a PTT application operating or limiting on an ANDROID smart phone. The PTT application may receive a PTT communication request over a WiFi communication link using TCP/IP protocol as the underlying transport. In this example, the smart phone running the PTT application may be switched into a “Do Not Disturb” setting by a user of the smart phone or automatically by the smart phone based on some condition being met. This “Do Not Disturb” setting triggers an autoreply to be created by the application in response to receiving the PTT communication request. The smart phone may be configured to produce an SMS autoreply with predefined text stating succinctly: “I am busy,” where “I” indicates the user of the smart phone. The application then may use a 3G link to send an SMS using the Short Message Protocol defined in the 3^{rd} Generation Partnership Project (3GPP) standards. The device which sent the PTT communication request may then receive the SMS stating “I am Busy” from the smart phone miming the PTT application, which provides closure to the PTT communication request.

In another specific example, an autoreply feature may be embedded in a PTT application running on an APPLE iPHONE. The application may receive a PTT communication request over a CDMA link using UDP/IP protocol as the underlying transport. The iPHONE may be set to a Do-Not-Disturb setting. Once the PTT communication request is received, it triggers an autoreply to be produced by the PTT application. The iPHONE may be configured to autoreply via an email in accordance with another setting. The PTT application may then use the iPHONE's WiFi link to establish an email connection using the IMAP protocol to communicate with an email server to send a predefined email to the device which sent the PTT communication request. In this example, the email may state: “You caught me at a bad time, please try back later.” This provides a response to the PTT communication request that allows the sender to realize why the PTT session was not opened by the intended receiver.

According to yet another specific example, an autoreply feature may be enabled in a smart phone chat/text application. The chat/text application may be set to autoreply if the smart phone is travelling at a speed that is faster than a predetermined walking speed of the user. If the smart phone is travelling at this elevated velocity, the user of the smart phone is presumably driving a car on the highway or travelling at high speeds in some other fashion. An incoming text may be delivered to the smart phone using the smart phone's 4G link with the underlying protocol being TCP/IP. In this case, the smart phone's autoreply may be set as a short canned video clip that will be sent out in response to a received text using MMS. The chat/text application may then use the smart phone's 4G link, but this time with a different protocol, specifically the Multimedia Messaging Protocol as defined in the 3GPP standards, to send the short video clip back to the originator device as the autoreply. The video clip may include a graphic which shows a car driving down a street with text stating “On my way, can't talk now,” or something to that effect.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A computer program product for responding to an incoming message, the computer program product comprising a computer readable storage medium having computer readable program code embodied therewith, the computer readable program code comprising:
computer readable program code configured for receiving an incoming message using a first application on a receiver communication device;
computer readable program code configured for processing the incoming message using the first application to determine details of the incoming message;
computer readable program code configured for determining to generate an autoreply to the incoming message using the first application;
computer readable program code configured for generating the autoreply to the incoming message using the first application; and
computer readable program code configured for sending the autoreply using the first application to at least a communication device which generated the incoming message.

2. The computer program product as recited in claim 1, further comprising computer readable program code configured for notifying a user at the receiver communication device of the incoming message using the first application.

3. The computer program product as recited in claim 1, wherein the autoreply is automatically generated based on one or more of the details of the incoming message.

4. The computer program product as recited in claim 1, wherein the autoreply is automatically generated based on a user setting in the first application.

5. The computer program product as recited in claim 1, wherein the autoreply is automatically generated based on one or more conditions comprising any of: a silent mode being active, a vibrate mode being active, a position of the receiver communication device relative to a reference position, an orientation of the receiver communication device relative to the reference position, recent movement of the receiver communication device, a velocity of the receiver communication device movement, a geographical location of the receiver communication device, a current time, user data stored to the receiver communication device, a user input to the receiver communication device, and ambient noise detected by the receiver communication device.

6. The computer program product as recited in claim 5, wherein content of the autoreply is dynamically generated based on the one or more conditions and details of the incoming message.

7. The computer program product as recited in claim 5, wherein content of the autoreply comprise user specified content and dynamically-generated content from the

8. The computer program product as recited in claim 1, wherein a user at the receiver communication device specifies content of the autoreply.

9. The computer program product as recited in claim 1, wherein a data type of the incoming message comprises at least one of: video data, audio data, text data, and image data.

10. The computer program product as recited in claim 9, wherein a data type of the incoming message is the same as a data type of the autoreply.

11. The computer program product as recited in claim 9, wherein a data type of the autoreply is different from a data type of the incoming message.

12. The computer program product as recited in claim 1,
wherein the autoreply is transmitted over a communication channel on which the incoming message is received,
wherein the autoreply utilizes the same communication protocol as the incoming message, and/or
wherein the autoreply is transmitted over a communication network on which the incoming message is received.

13. The computer program product as recited in claim 1, wherein the autoreply is sent to a plurality of recipient devices according to a group communication setting.

14. A method for automatically replying to a message, the method comprising:
receiving an incoming message using a first application on a receiver communication device;
notifying a user at the receiver communication device of the incoming message using the first application;
processing the incoming message using the first application to determine details of the incoming message;
determining to generate an autoreply to the incoming message using the first application;
generating the autoreply to the incoming message using the first application; and
sending the autoreply using the first application to at least a communication device which generated the incoming message.

15. The method as recited in claim 14,
wherein the autoreply is automatically generated based on at least one of: details of the incoming message and a user setting in the first application, and
wherein the autoreply is automatically generated based on one or more conditions comprising any of: a silent mode being active, a vibrate mode being active, a position of the receiver communication device relative to a reference position, an orientation of the receiver communication device relative to the reference position, recent movement of the receiver communication device, a velocity of the receiver communication device movement, a geographical location of the receiver communication device, a current time, user data stored to the receiver communication device, a user input to the receiver communication device, and ambient noise detected by the receiver communication device.

16. The method as recited in claim 15, wherein content of the autoreply comprises at least one of: user specified content and dynamically-generated content from the first application based on the one or more conditions and details of the incoming message.

17. The method as recited in claim 14, wherein a user at the receiver communication device specifies content of the autoreply.

18. The method as recited in claim 14,
wherein the autoreply is transmitted over a communication channel on which the incoming message is received,
wherein the autoreply utilizes a communication protocol of the incoming message, and/or
wherein the autoreply is transmitted over a communication network on which the incoming message is received.

19. The method as recited in claim 14, wherein the autoreply is sent to a plurality of recipient devices according to a group communication setting.

20. A communication device, comprising:
a processor adapted for executing logic;
logic adapted for receiving an incoming message using a first application;
logic adapted for notifying a user of the incoming message using the first application;
logic adapted for processing the incoming message using the first application to determine details of the incoming message;
logic adapted for determining to generate an autoreply to the incoming message using the first application;
logic adapted for generating the autoreply to the incoming message using the first application; and
logic adapted for sending the autoreply using the first application to at least a communication device which generated the incoming message.
